(19) United States
(12) Patent Application Publication
(10) Pub. No.: US 2014/0151503 A1
(43) Pub. Date: Jun. 5, 2014

(54) DEVICE FOR AERIAL TRANSPORTATION AND TREATMENT OF PATIENTS IN LITTERS

(71) Applicant: EADS Construcciones Aeronauticas, S.A., Getafe (ES)

(72) Inventors: José Luis DE LA FUENTE CARNERO, Getafe (ES); Luis VÁZQUEZ VELASCO, Getafe (ES)

(21) Appl. No.: 14/093,365

(22) Filed: Nov. 29, 2013

(30) Foreign Application Priority Data
Nov. 30, 2012 (ES) 201231866

(51) Int. Cl. B64D 11/06

(52) U.S. Cl. CPC B64D 11/06
USPC 244/118.6

(57) ABSTRACT

A device for aerial transportation and treatment of patients in litters. The device comprises several structural elements (legs, upright posts, litter clamping arms, reinforcing members) and several connecting terminals between them allowing its installation in commercial aircraft quickly and easily, without any tools. The structural elements are formed by hollow metallic profiles, preferably of aluminum, of square section, including in their four faces recessed channels with undulated walls such as the rails of the AS 33601 standard.

### CROSS-REFERENCES TO RELATED APPLICATIONS

This application claims the benefit of the Spanish patent application No. 201231866 filed on Nov. 30, 2012, the entire disclosures of which are incorporated herein by way of reference.

### FIELD OF THE INVENTION

The present invention relates to a device for aerial transportation and treatment of patients in litters which can be installed on commercial aircraft.

### BACKGROUND OF THE INVENTION

The high cost of purchasing and maintaining a fleet of aircraft makes it essential to reduce its size, adjusting it to the operational needs. Therefore aircraft capable of performing various missions without compromising their availability and minimizing associated adaptation costs are required. This versatility is achieved by changes to the interior layout of the cabin of said aircraft.

Traditionally, these changes in the cabin require a great economic effort that reduces profitability. In addition, it is necessary to properly plan the time window in which the aircraft shall be in the hangar for the adaptation tasks. All of this means that adaptation operations are very expensive and require a long time.

When the above applies to medical missions, such as medical evacuation, for which fleets are often not prepared, the time needed to change the aircraft configuration is critical to ensure an effective response to the unexpected demand for this type of missions.

In purely military aircraft having a rear ramp or a cargo door, load handling systems, typically using rollers, are installed for aeromedical evacuation missions and these systems facilitate configuration changes of these military aircraft. However, the problem posed by configurations of this type is that these load handling systems heavily penalize the operating empty weight of the aircraft.

In a typical civil aircraft, aeromedical evacuation systems currently used are not compatible with the passenger cabin layout if the aircraft is not designed specifically to house these systems.

Thus, in war or in emergency situations such as natural disasters or areas contaminated by chemicals or radiation, there are insufficient military or civilian aircraft adapted for rapid evacuation of the wounded from the affected areas.

Devices such as the one described in U.S. Pat. No. 6,923,606, comprising litter stanchion sets and passenger seats fixed to a pallet, are known in the art. These devices are installed in a transport means such as an aircraft when necessary. These devices require complicated operations for their mounting and lack of flexibility for, particularly, their installation on commercial aircraft.

For these reasons, it is desirable to provide devices that allow the aerial transportation and treatment of patients on litters by performing configuration changes to any aircraft that has rails on the floor of his cabin.

The present invention is directed to provide such devices.

### SUMMARY OF THE INVENTION

An object of the present invention is to provide a device for aerial transportation and treatment of patients on litters which can be installed in any aircraft that has rails on the floor of the cabin. In particular, the device developed by the invention can be installed in commercial aircraft comprising rails for the installation of seats designed according to AS 33601 standard, i.e., rails including on its upper side a recessed channel with undulated walls.

More particularly, the device developed by the invention can be installed in an aircraft quickly and easily, without tools, so as to allow an aircraft to be configured to carry out missions of medical care and evacuation of wounded, especially in emergency situations, without further structural modification that disassembly of the seats in the area intended for its installation. The device of the invention is also a modular device that can be tailored to the needs and configured so that it suits them.

The device of the invention allows installation in the aircraft cabin of NATO standard litters or any other litter whose dimensions fall within certain ranges as well as the installation of medical equipment for the treatment of intensive care patients.

The device of the invention comprises several structural elements (legs, upright posts, clamping arms of litters, reinforcing members) and several connecting terminals between them that facilitate their installation without the need of using tools. The configuration of, in particular, the connecting terminals of the legs to the rails of the aircraft is an important feature of the device.

The structural elements are formed by metallic profiles, preferably of aluminum, having a transversal square section, that include in their four sides recessed channels with undulated walls such as those of the rails of the AS 33601 standard. This configuration allows the installation of brackets of medical equipment in any side of such structural elements and facilitates the union of the structural elements.

The device of the invention can be installed whether in one side of the cabin of the aircraft, then preferably being configured to house two or more litters (if the height of the cabin allows) or in the central area of the aircraft, being then preferably configured to house four or more litters (if the height of the cabin allows).

Other characteristics and advantages of the present invention will be clear from the following detailed description of embodiments illustrative of its object in relation to the attached Figures.

### BRIEF DESCRIPTION OF THE DRAWINGS

FIG. 1 is a perspective view of an embodiment of the device for aerial transportation and treatment of patients in litters according to the present invention for two litters.

FIG. 2 is a perspective view of a leg of the device for aerial transportation and treatment of patients in litters according to the present invention.

FIG. 3 is a perspective view of the components of the connecting terminal of the legs of the device for aerial transportation and treatment of patients in litters according to the present invention to the rails of the aircraft.

FIG. 4 is a perspective view of an upright post of the device for aerial transportation and treatment of patients in litters according to the present invention.

FIG. 5 is a perspective view of a clamping arm of litters of the device for aerial transportation and treatment of patients in litters according to the present invention.

FIG. 6 is a perspective view of a horizontal bar connecting the ends of the clamping arms of the device for aerial transportation and treatment of patients in litters according to the present invention.

FIG. 7a is a perspective view of the adjustable diagonal element of the device for aerial transportation and treatment of patients in litters according to the present invention and FIGS. 7b, 7c, 7d, 7e are detailed views of its bottom end in two positions of its braking mechanism.

FIG. 8 is a perspective view of the beam used in various structural elements of the device for aerial transportation and treatment of patients in litters according to the present invention.

FIGS. 9a, 9b, 10a and 10b are perspective views of two embodiments of brackets of medical oxygen bottles or other sanitary equipment.

FIG. 11 is a perspective view of one embodiment of the device for aerial transportation and treatment of patients in litters according to the present invention including intensive care elements.

FIG. 12 is a perspective view of an embodiment of the device for aerial transportation and treatment of patients in litters according to the present invention for four litters.

FIG. 13 is a perspective view of an example of installation of three devices for aerial transportation and treatment of patients in litters according to the present invention.

### DETAILED DESCRIPTION OF THE PREFERRED EMBODIMENTS

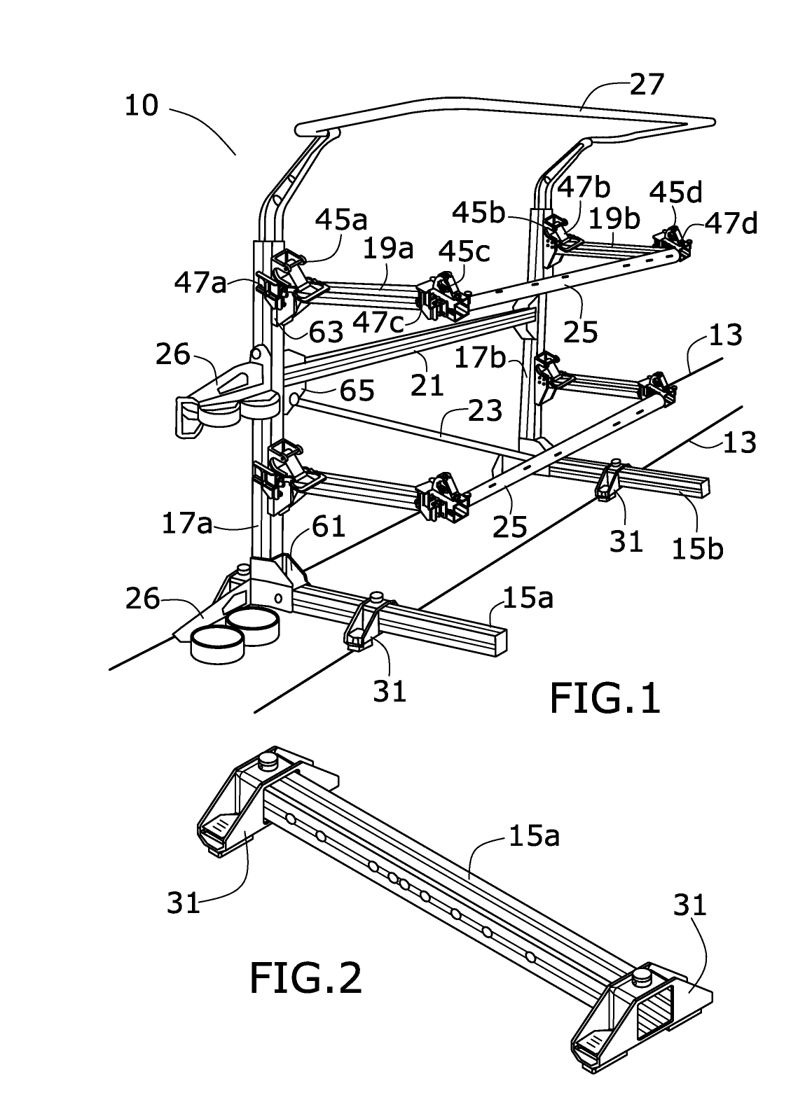

The device for aerial transportation and treatment of patients in litters according to the embodiment present invention shown in FIG. 1, intended for installation in a side of an aircraft, comprises the following structural elements:
Two legs 15a, 15b disposed transversely to the rails 13 of the aircraft and attached to them by first connecting terminals 31.
Two upright posts 17a, 17b attached to the legs 15a, 15b by second connecting terminals 61.
Two pairs of clamping arms 19a, 19b joined to the upright posts 17a, 17b by third connecting terminals 63 to hold two litters (not shown). To this end, each pair has receiving elements 45a, 45b, 45c, 45d of litter sticks arranged on the upper face of the clamping arms 19a, 19b. They also include stops 47a, 47b, 47c, 47d attached to their outer sides to prevent longitudinal movement of litters.
A horizontal beam 21 connected to the upright posts 17a, 17b in a middle position between the two pairs of clamping arms 19a, 19b by fourth connecting terminals 65. This horizontal beam 21 is the element that gives continuity to the two sets of legs and upright posts 15a, 17a; 15b, 17b.
An adjustable diagonal element 23 for joining the two upright posts 17a, 17b.

With the exception of the adjustable diagonal element 23, all the mentioned structural elements are hollow metallic profiles 20, preferably aluminum profiles, of square transversal section with recessed channels 40 with undulated walls like the rails according to the AS 33601 standard on their four sides (see FIG. 8). This configuration provides them great flexibility to create connections and fix devices every inch with standard systems widely used in the aeronautic industry.

The device 10 according to the embodiment of the invention shown in

FIG. 1 also comprises:
Horizontal bars 25 which join the ends of the clamping arms 19a and 19b and can hold medical equipment.
Brackets 26 for medical oxygen bottles or other equipment needed for treatment of patients.
Supporting elements of curtains 27, to facilitate privacy of the patients occupying the litters, attached to the top of the upright posts 17a, 17b by pins. To adapt them to the height available in the aircraft extenders that can be coupled to the top of the upright posts 17a, 17b are available. On the other hand, the bases of these supporting elements of curtains 27 are designed with a curved shape to fit the lateral the side of the aircraft.

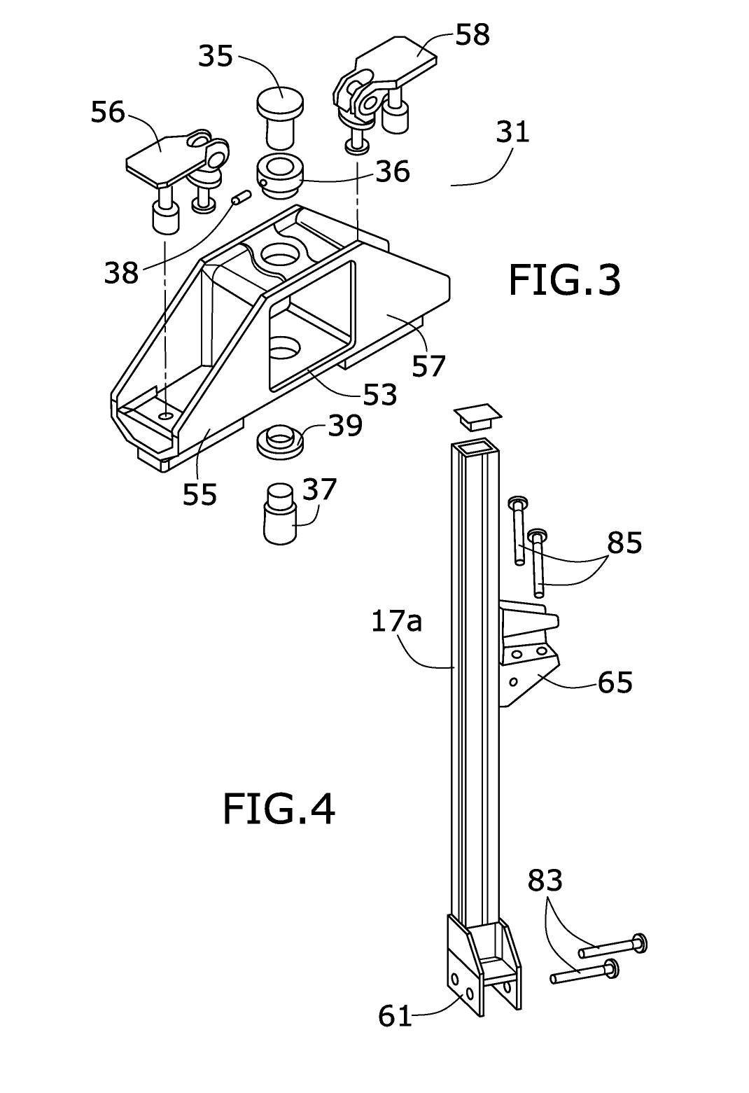

Following FIG. 3 it can be seen that the first connecting terminals 31 are configured with a central hollow body 53 and two lateral bodies 55, 57 so that the legs 15a, 15b remain disposed within two first connecting terminals 31 and these are fixed to the rails 13 in said lateral bodies 55, 57 by quick disconnect fixing fittings 56, 58. The central hollow body 53 is configured with a slightly larger section than the legs 15a, 15b to have a certain clearance with them.

The first connecting terminals 31 can move along legs 15a, 15b to be positioned on the rails 13. To that end have an upper pin 35 with two parallel grooves cooperating with a bushing 36 provided with a positioner 38 to secure the upper pin 35 in said grooves defining two working positions. The upper pin 35 may be disposed on the first connecting terminal 31 in a first position where it does not interfere with a leg disposed therein and thus can be moved in position along legs 15a, 15b. It can also be arranged in a second position locking this displacement.

They also have a lower threaded bolt 37 cooperating with a nut 39. The lower threaded bolt 37, when not secured, projects below the first connecting terminal 31 for safety reasons, so as to interfere with the top of the rails 13 of the aircraft and does not allow joining the legs 15a 15b to the rails 13 of the aircraft.

On the other hand, the upper pin 35 and the lower threaded bolt 37 form an axis that allows a slight rotation of the first connecting terminals 31 to facilitate its coupling to the rails 13 of the aircraft and reduce the loads of legs 15a, 15b in cases of demanding loads.

Following FIG. 4 it can be seen that the upright post 17a incorporates (by means of, for example, rivets) a second connecting terminal 61 which allows attachment to the leg 15a and a fourth connecting terminal 65 which allows joining him to the horizontal beam 21. These unions are carried out by, respectively, the pins 83, 85 facilitating therefore the installation of the device 10 without tools. For this purpose, the recessed channels 40 of, respectively, the leg 15a and the horizontal beam 21 include engaging holes with said pins 83, 85. Additionally, the second connecting terminals 61 can incorporate a quick-disconnect fixing fitting for attachment to the upper face of the leg 15a.

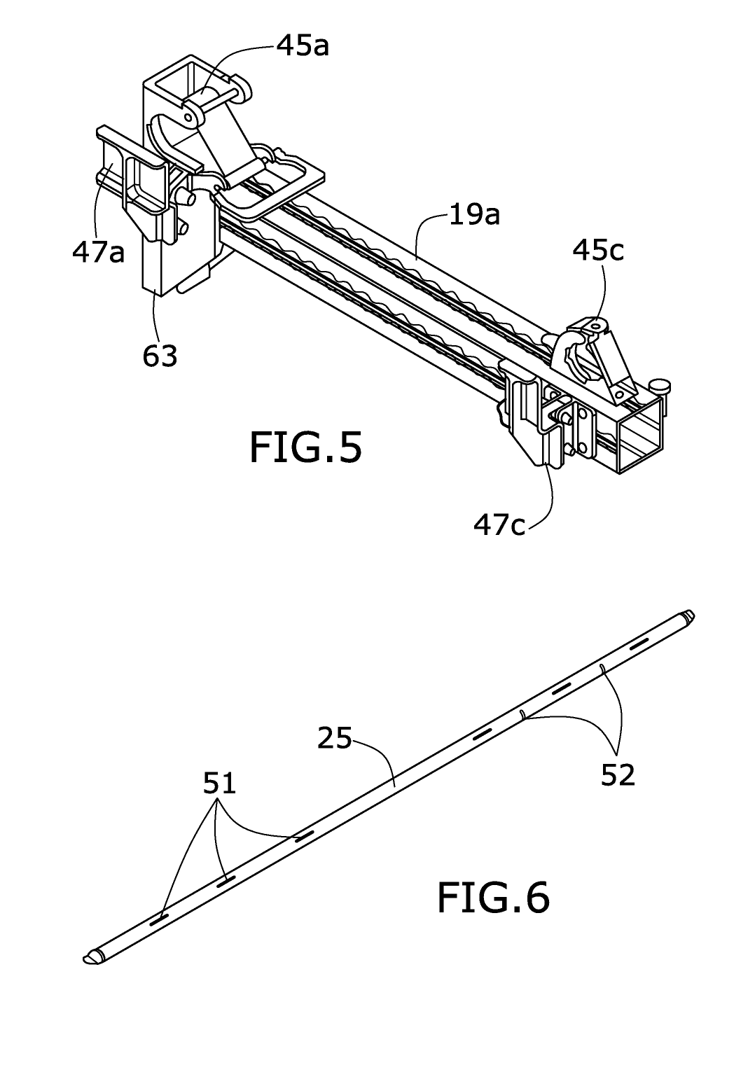

Following FIG. 5 it can be seen that the clamping arm 19a incorporates (by means of, for example, rivets) a third connecting terminal 63 which allows attachment to the upright post 17th through a quick-disconnect fixing fitting. It can also be observed that stops 47a, 47c, limiting the longitudinal movement of the litter, avoiding therefore the dangers of a catastrophic landing, are arranged in front of the receiving elements 45a, 45c of the litter sticks. The stop 47a is attached to the third connecting terminal 63 and the stop 47c to the clamping arm 19a. In both cases, the joining is carried out by means of two pins, one fixed to permit rotation of the stop on it and another detachable allowing its withdrawal.

Following FIG. 6 it can be seen that the horizontal bar 25 comprises multiple slits 51 that facilitate the installation of medical equipment and projections 52 between them to minimize the rotation of brackets in case they are used for fastening the equipment.

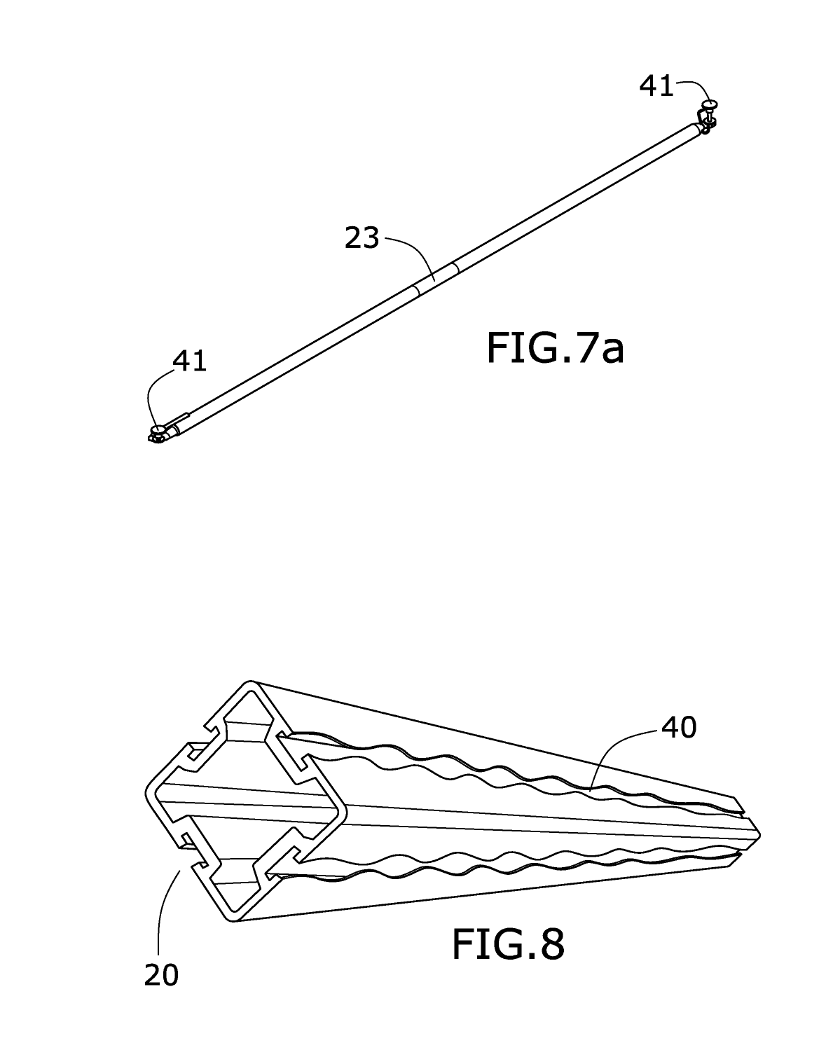

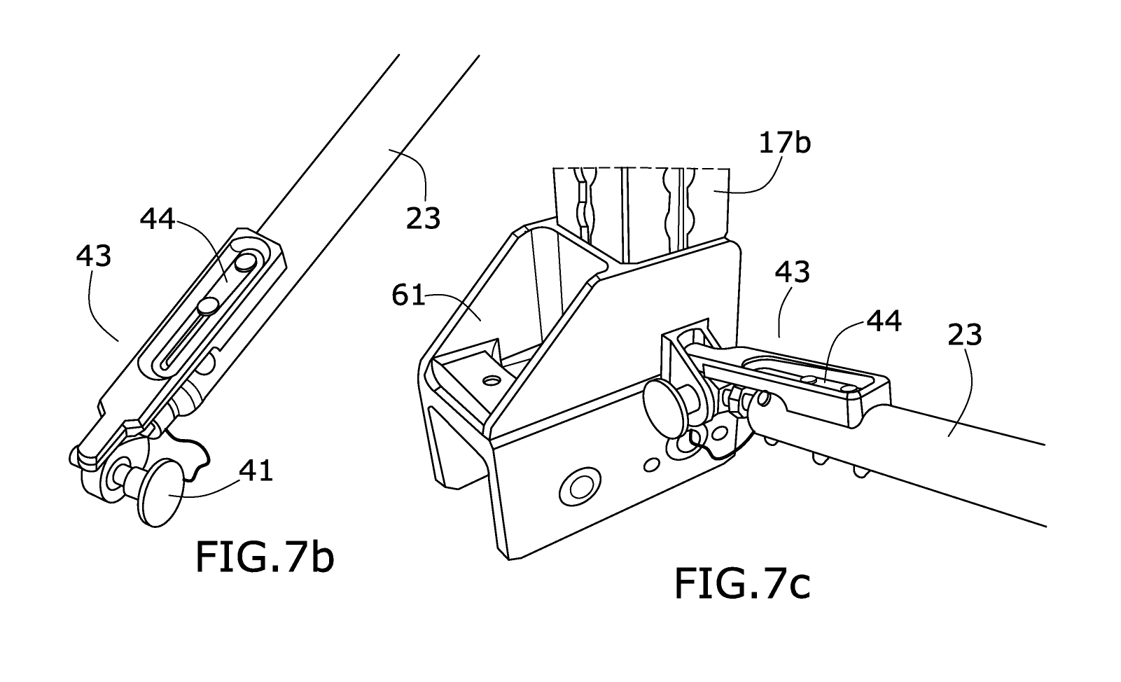

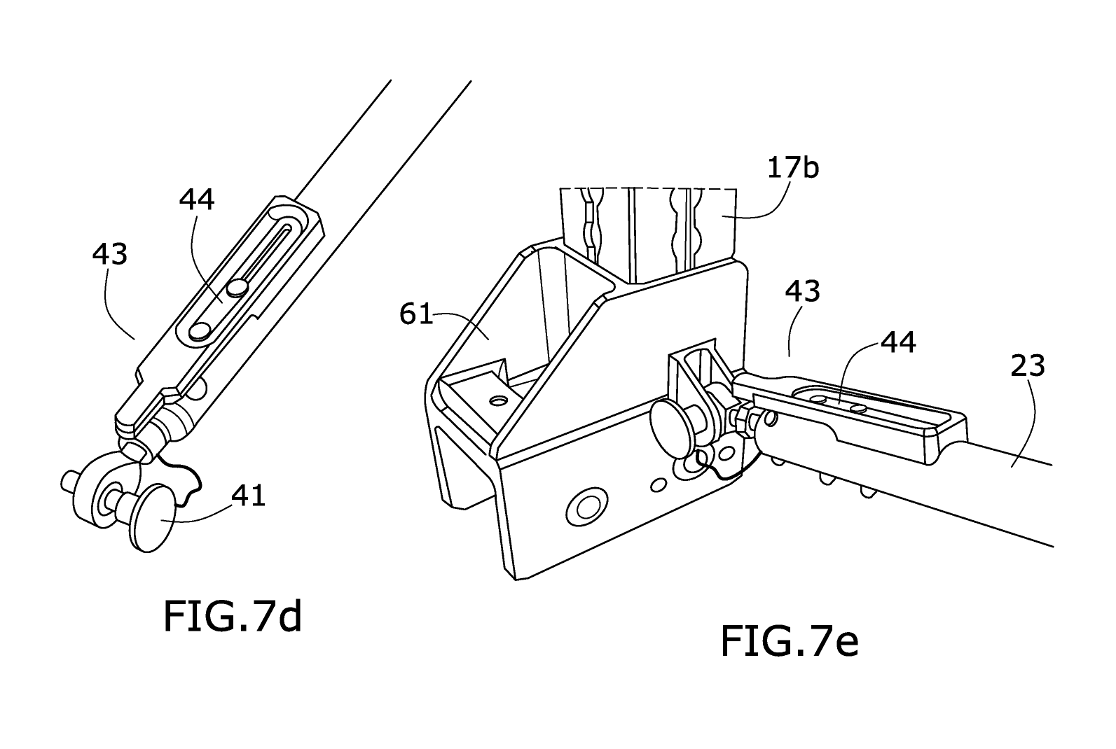

Following FIGS. 7a, 7b, 7c, 7d, 7e it can be seen that the adjustable diagonal element 23 has threaded terminals 41 for final adjustment of the device 10. Its upper end is attached to the fourth terminal 65 which joins the upright post 17a with the horizontal beam 21 and its lower end to the second terminal 61 which joins the upright post 17b with the leg by pins. By turning the adjustable diagonal element 23 the clearances between the parts of the device 10 are eliminated. At its lower end it is equipped with a braking mechanism 43 that prevents relaxation during flight. To prevent in-flight vibration from rotating the adjustable diagonal element 23 and releasing the tension of device 10, the braking mechanism 43 comprises a locking element 44 which is movable manually to fix the adjustable diagonal element 23 to the upright posts 17a, 17b thus preventing any movement of said adjustable diagonal element 23 (FIGS. 7b, 7c). When the locking element 44 is displaced in the opposite direction (FIGS. 7d, 7e) the rotation of the adjustable diagonal element 23 is possible.

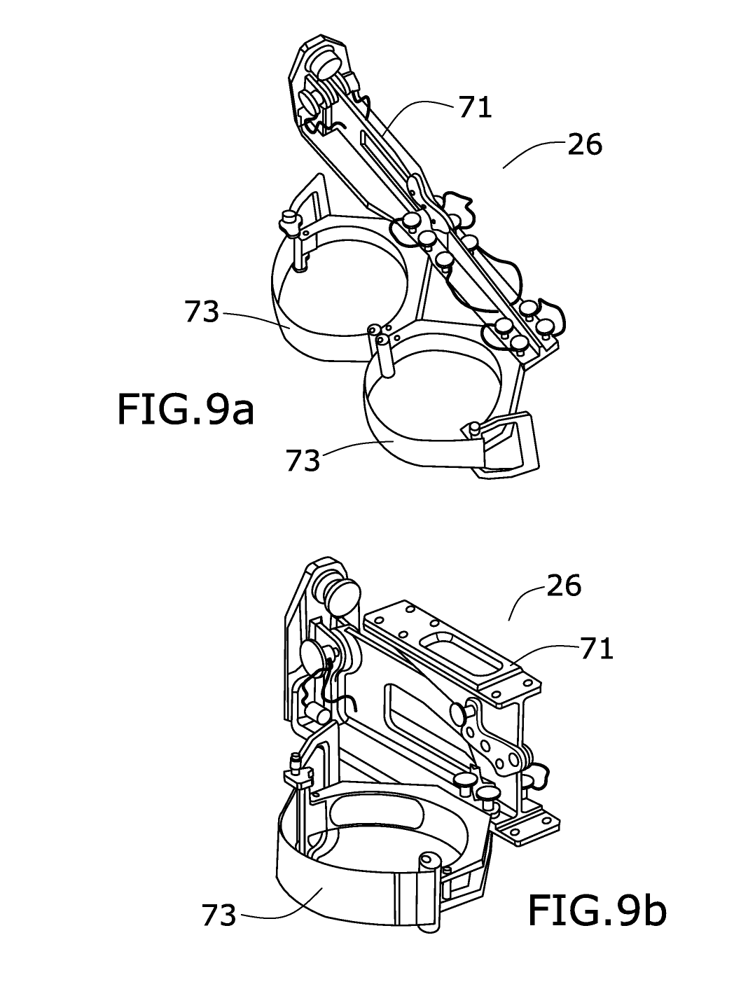

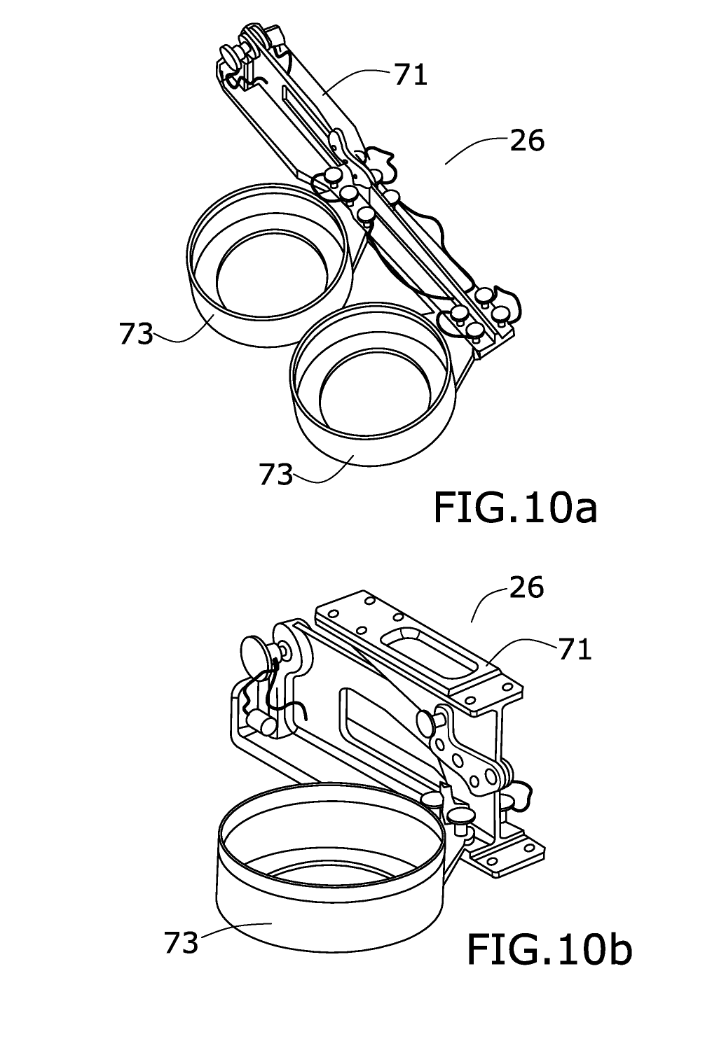

FIGS. 9a, 9b show brackets 26 of containers of medical products (for example, oxygen bottles) that shall be located in an elevated position in the device 10 attached to one of the upright posts 17a, 17b and FIGS. 10a, 10b show brackets 26 of containers of medical products (for example, oxygen bottles) that shall be located at a lower position in the device 10 attached to a second connecting terminal 61 incorporated in one of the upright posts 17a, 17b (see also FIG. 1). In both cases the bracket 26 comprises a central beam 71 to which are attached the cups 73 where the containers would be located and is structured so that it can be set in the unfolded state shown in FIGS. 9a and 10a for holding two containers or in the folded state shown in FIGS. 9b, 10b with a single cup for holding a container (the other is removed).

The device 10 may also include other brackets of medical and sanitary equipment arranged in appropriate locations thereof.

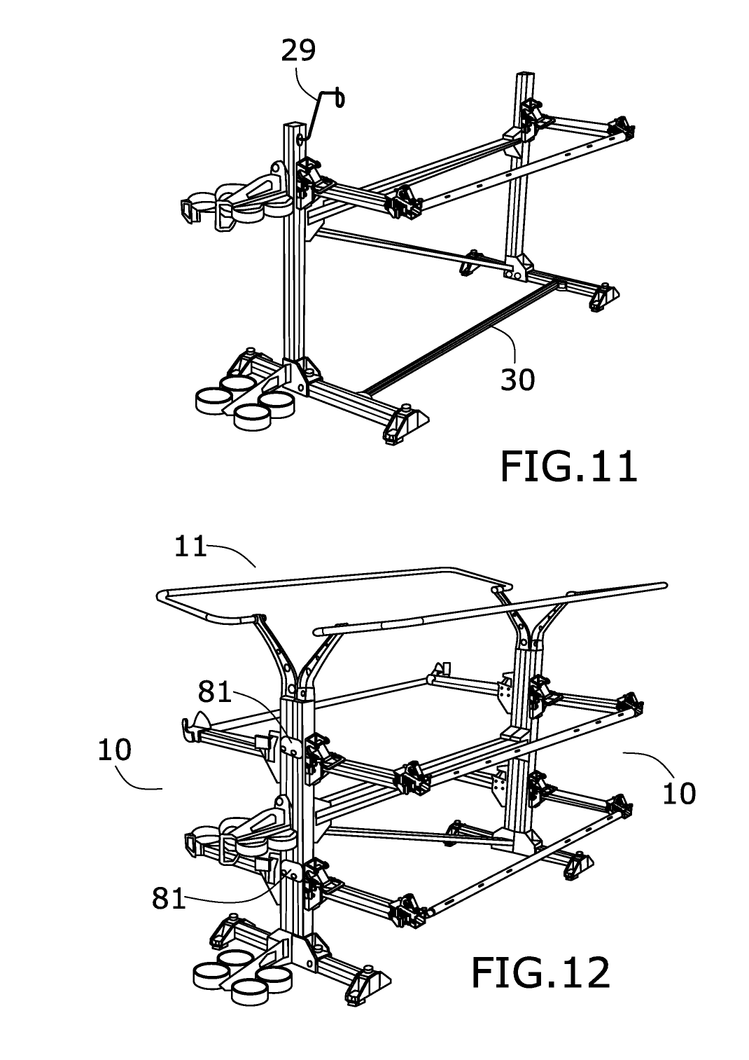

FIG. 11 shows an embodiment of the device 10 with an intensive care unit at the bottom that includes two additional elements: a lower bar 30 attached to legs 15a, 15b for mounting thereon a drawer and a support 29 for bags of fluids.

With the above elements, the device 10 can be quickly installed without tools. The installation can be done in less than 10 minutes by two operators. The different elements of the device 10 are marked with instructions for easy installation without the need to consult the drawings.

In turn, due to its modular nature, the device 10 may take various configurations to meet different needs. In particular the disposition of the auxiliary elements (horizontal bar 25, supporting elements for curtains 27, bar 28 for intensive care unit and brackets 26) may differ from that shown in the Figures.

FIG. 12 shows a device 11 which comprises two devices 10 as those that have been described, with the exception of the common legs, joined by their upright posts by means of parts 81 and having the clamping arms of each device 10 extended in opposite directions.

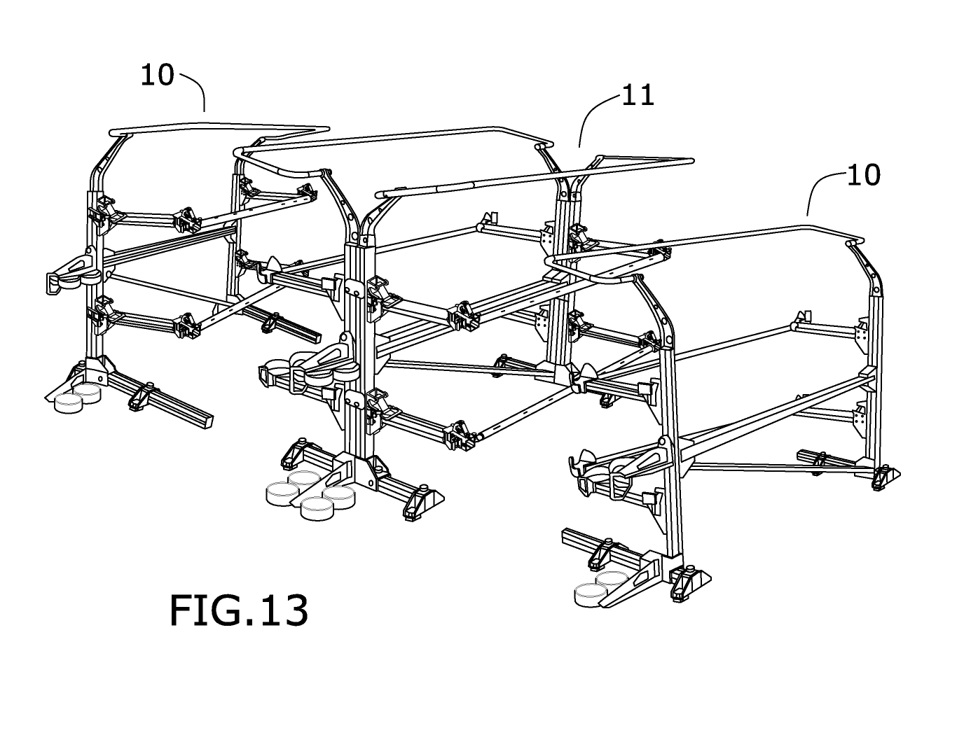

FIG. 13 shows two devices 10 configured to support two litters and a tandem device 11 configured to support four litters as would be arranged in an area of an aircraft. The aisle between them meets the aeronautical regulations related to the width of the main aisles in emergency evacuations. Furthermore, the horizontal bars 25 on their sides provide a guide for evacuation of the aircraft preventing that the passengers may enter into the devices if the litters would not be installed. These horizontal bars 25 together with the supporting elements for curtains 27 provide a firm handhold along the aisles as required by aeronautic regulations.

If the above mentioned devices for aerial transportation of litters must be installed in an area previously occupied by passenger seats, their installation would take place after removing the seats, locating the devices under the luggage area.

As an installation example, the steps required to install a device 11 for aerial transportation of litters are detailed below:

a) having the legs 15a, 15b, with the first connecting terminals 31 mounted on them, in the correct position;

b) fixing the first connecting terminals 31 to the rails 13 of the aircraft in the proper position and blocking them afterwards;

c) installing the pairs of upright posts 17a and 17b on each leg 15a, 15b in the position marked for each of them;

d) installing the two horizontal beams 21 between the pairs of upright posts 17a and 17b;

e) installing the two adjustable diagonal elements 23 coupled in the pair of upright posts 17a and 17b coordinating the direction of these diagonal elements 23 with the direction of flight of the aircraft;

f) installing the supporting elements for curtains 27;

g) installing the pairs of clamping arms 19a, 19b in the pairs of upright posts 17a and 17b and the horizontal bars 25 at the ends of the pairs of clamping arms 19a, 19b;

h) tensioning the adjustable diagonal elements 23, eliminating clearances, until the whole assembly appears sufficiently stiff and blocking them afterwards;

i) installing the brackets 26 of sanitary devices as necessary.

Although the present invention has been described in connection with various embodiments, it will be appreciated from the specification that various combinations of elements, variations or improvements therein may be made, and are within the scope of the invention.

1. A device for aerial transportation and treatment of patients in litters installable on rails arranged on the floor of the cabin of an aircraft for installation of at least one of seats and other equipment on the rails; the device including structural elements comprising:
two legs arranged transversely to the rails,
at least two upright posts attached to the legs,
one or more pairs of clamping arms for holding litters attached to the upright posts and
reinforcing elements attached to the upright posts,
the device further comprising:
at least said structural elements being made of hollow metallic profiles of a square transversal section that include in their four faces, recessed channels with undulated walls to cooperate with quick disconnect fixing fittings of other elements to said legs, posts and clamping arms;
first connecting terminals of the legs with the rails being formed by a central hollow body and two lateral bodies,
the central hollow body being configured with a suitable shape to house inside it said legs, enabling the displacement of the first connecting terminals along them,
the central hollow body being provided with means to selectively allow and prevent such displacement, and control means for the correct positioning of the first connecting terminals on the rails,
the lateral bodies being provided with quick disconnect fixing fittings engageable with the rails.

2. The device according to claim 1, wherein said rails are made of hollow metallic profiles whose upper face includes a recessed channel with undulated walls to cooperate with quick disconnect fixing fittings of other elements on the rails.

3. The device according to claim 2, wherein:
the means allowing and preventing the displacement of the first connecting terminals on the rails comprises an upper pin with two parallel grooves and a bushing with an internal positioner cooperating with said grooves so that the upper pin can placed in a first position allowing the displacement of the first connecting terminals over the legs and in a second position where such displacement is blocked;
the control means for the correct positioning of the first connecting terminals on the rails comprise a lower threaded bolt and a cooperating nut so that the lower threaded bolt can be placed in a first position in which interferes with the rails and in a second position in which it does not.

4. The device according to claim 1, wherein said reinforcing elements comprise a horizontal beam configured by hollow a metallic profile of square transversal section that includes in its four faces recessed channels with undulated walls to cooperate with quick disconnect fixing fittings of other elements to said horizontal beam and an adjustable diagonal element attached to two vertical upright posts.

5. The device according to claim 4, wherein the upright posts include second connecting terminals with the legs and fourth connecting terminals with the horizontal beam, wherein the clamping arms include third connecting terminals with the upright posts and wherein the union of said connecting terminals to said structural elements is effected by at least one of quick disconnect fixing fittings cooperating with the recessed channels of their profiles and pins cooperating with holes provided in said connecting terminals and in the floor of said recessed channels.

6. The device according to claim 4, wherein the diagonal adjustable element comprises threaded terminals for adjustment to the upright posts, such that by rotation of the diagonal element, clearances are eliminated and greater rigidity is achieved, and a retractable braking mechanism in one of the ends of the diagonal adjustable element which prevents relaxation during flight of the aircraft.

7. The device according to claim 1, wherein each pair of clamping arms for holding litters comprises receiving elements of the litter sticks joined to their upper faces and stops attached to their outer side faces so that the clamping arms can adopt a first position facing said receiving elements to prevent longitudinal movements of the litter and a second lowered position with respect to said receiving elements allowing said longitudinal movements of the litter.

8. The device according to claim 1, further comprising at least one horizontal bar attached to the outer ends of a pair of clamping arms for holding litters, the horizontal bar being provided with slits intended for the installation of brackets of medical equipment, and being provided with projections between the slits to minimize the rotation of said equipment.

9. The device according to claim 1, further comprising brackets of medical equipment connected to any of the structural elements and supporting elements for privacy curtains attached to the upright posts.

10. The device according to claim 1, further comprising a lower bar for supporting a drawer.

11. The device according to claim 1, wherein said hollow metallic profiles are made of aluminum.

12. The device according to claim 1, comprising two upright posts and two pairs of clamping arms.

13. The device according to claim 1, comprising two pairs of upright posts and two pairs of clamping arms connected to each pair of upright posts, being joined together said pairs of upright posts by parts and being said pair of clamping arms extended in opposite directions.
